(19) United States
(12) Patent Application Publication
(10) Pub. No.: US 2026/0147558 A1
(43) Pub. Date: May 28, 2026

(54) BUILDING MANAGEMENT SYSTEM DEVICE WITH CONTAINERIZATION FOR DELIVERING AND APPLYING UPDATE PACKAGES

(71) Applicant: Tyco Fire & Security GmbH, Neuhausen am Rheinfall (CH)

(72) Inventors: Colton J. Agathen, Milwaukee, WI (US); Kaleb C. Luedtke, West Bend, WI (US); Gary W. Gavin, Franklin, WI (US)

(21) Appl. No.: 18/957,377

(22) Filed: Nov. 22, 2024

(51) Int. Cl. G06F 8/65; G06F 8/61

(52) U.S. Cl. CPC G06F 8/65; G06F 8/63

(57) ABSTRACT

A BMS device includes a system and method for delivering and applying updates to a host machine. The BMS device includes one or more processors and memory storing instructions. The BMS device includes a container image repository storing container images used to initialize and execute a container containing an update package. The BMS device includes a mount point which is configured to store the update package copied from the container. The container is configured to send a message from the container to a host machine. The host machine is configured to receive the message and in response extract the update package from the mount point and apply the update package to one or more components of the host machine.

### BACKGROUND

The present disclosure relates generally to building management systems. The present disclosure relates more particularly to building management system devices.

A building management system (BMS) is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include METASYS® building controllers or other devices sold by Johnson Controls, Inc., as well as building devices and components from other sources.

A BMS may include one or more computer systems (e.g., servers, BMS controllers, etc.) that serve as enterprise level controllers, application or data servers, head nodes, master controllers, or field controllers for the BMS. Such computer systems may communicate with multiple downstream building systems or subsystems (e.g., an HVAC system, a security system, etc.) according to like or disparate protocols (e.g., LON, BACnet, etc.). The computer systems may also provide one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the BMS, its subsystems, and devices.

### SUMMARY

One implementation of the present disclosure is a system for delivering and applying updates to building management system (BMS) devices including a container image repository storing a plurality of container images and a BMS device comprising one or more processors and memory storing instructions that, when executed by one or more processors, cause the one or more processors to perform operations comprising obtaining a container image from the container image repository, initializing and executing a container on the BMS device using a container image, wherein the container comprises an isolated computing environment isolated from a host machine of the BMS device and executing the container comprises copying an update package from the isolated computing environment within the container to a mount point accessible by the container and the host machine, and sending a message from the container to the host machine, wherein the message causes the host machine to access the update package in the mount point and update one or more components of the host machine using the update package.

In some embodiments, the BMS device is configured to receive a run command specifying a container image, determine whether the container image is present on the host machine, and in response to the container image being absent from the host machine, obtain the container image from the container image repository.

In some embodiments, the BMS device is configured to utilize a compose function, wherein the compose function initializes the container utilizing first instructions in the container image.

In some embodiments, the BMS device is configured to verify the container image using an inbuilt content trust system installed on the host machine.

In some embodiments, the update package comprises at least one of a software update, an arbitrary command, or script file configured to update the host machine.

In some embodiments, the message is an interprocess communication message comprising a D-Bus command wherein the message is sent via a host abstraction layer to an application programming interface endpoint on the host machine.

In some embodiments, the BMS device is configured to verify whether one or more components of the host machine updated successfully and in response to determining that one or more components of the host machine failed to update successfully, repeat initializing and executing the container using the container image, sending the message from the container to the host machine, accessing the update package in the mount point, and updating the one or more components of the host machine using the update package.

In some embodiments, the BMS device is configured to verify whether one or more components of the host machine updated successfully and in response to determining that the one or more components updated successfully, removing the container from the BMS device.

In some embodiments, the BMS device is configured to update at least one of an operating system, a system service, an arbitrary file, the container image, or the container according to the update package.

Another implementation of the present disclosure is a method for delivering and applying updates to building management system (BMS) devices comprising obtaining, by a BMS device, a container image from a container image repository, initializing and executing a container on the BMS device using the container image, wherein the container comprises an isolated computing environment isolated from a host machine of the BMS device and executing the container comprises copying an update package from the isolated computing environment within the container to a mount point accessible by both the container and the host machine, and sending a message from the container to the host machine, wherein the message causes the host machine to access the update package in the mount point and update one or more components of the host machine using the update package.

In some embodiments, obtaining the container image comprises receiving a run command that specifies the container image, determining whether the container image is present on the host machine, and in response to the container image being absent from the host machine, obtaining the container image from the container image repository.

In some embodiments, initializing and executing the container comprises utilizing a compose function, wherein the compose function initializes the container utilizing first instructions in the container image.

In some embodiments, obtaining the container image comprises, verifying the container image using an inbuilt content trust system installed on the host machine.

In some embodiments, the update package comprises at least one of a software update, an arbitrary command, or script file, configured to update the host machine.

In some embodiments, the message is an interprocess communication message comprising a D-Bus command wherein the message is sent via a host abstraction layer to an application programming interface endpoint on the host machine.

In some embodiments, the method for delivering and applying updates to building management system devices comprises verifying whether the one or more components of the host machine updated successfully, in response to determining that the one or more components of the host machine failed to update successfully, repeat initializing and executing the container using the container image, sending the message from the container to the host machine, accessing the update package in the mount point, and updating one or more components of the host machine using the update package.

In some embodiments, the method for delivering and applying updates to building management system devices comprises verifying whether the one or more components of the host machine updated successfully and in response to determining that one or more components of the host machine updated successfully, removing the container from the host machine.

In some embodiments, the method for delivering and applying updates to building management system devices comprises updating at least one of an operating system, a system service, an arbitrary file, the container image, or the container according to the update package

Another implementation of the present disclosure is a system for delivering and applying updates to building management system (BMS) devices comprising one or more non-transitory computer-readable media storing instructions that, when executed by one or more processors, cause the one or more processors to perform operations comprising obtaining, by a BMS device, a container image from a container image repository, initializing and executing the container image on the BMS device using the container image, wherein the container comprises an isolated computing environment isolated from a host machine of the BMS device and executing the container comprises copying an update package from the isolated computing environment within the container to a mount point accessible by both the container and the host machine, and sending a message from the container to the host machine, wherein the message causes the host machine to access the update package in the mount point and update one or more components of the host machine using the update package.

In some embodiments, the BMS device is configured to verify whether one or more components of the host machine updated successfully and in response to determining that the one or more components updated successfully, removing the container from the BMS device.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a building management system (BMS), according to some embodiments.

FIG. 2 is a block diagram of a BMS that serves the building of FIG. 1, according to some embodiments.

FIG. 3 is a block diagram of a building management system which can be used to monitor and control the building of FIG. 1, according to some embodiments.

FIG. 4 is a block diagram of an example system including an example building management system device that implements containerized update packages, in accordance with one or more implementations.

FIG. 5 is a block diagram of an example container image that may be implemented by the building management system device described in connection with FIG. 4, in accordance with one or more implementations.

FIG. 6 is a flow diagram of an example method for delivering and applying update packages to a building management system device, in accordance with one or more implementations.

FIG. 7 is a flow diagram of an example method for obtaining a container image from a container image repository, in accordance with one or more implementations.

FIG. 8 is a flow diagram of an example method for delivering and applying update packages to a building management system device in response to a failure to update one or more components of the host machine successfully, in accordance with one or more implementations.

### DETAILED DESCRIPTION

### Overview

Referring generally to the FIGURES, a BMS device with systems and methods for delivering and applying updates is shown, according to some embodiments. A BMS device, in general is a device that can be used to control, automate, or otherwise contribute to an environment, state, or condition of a building. A BMS device can include, for example controllers, chillers, rooftop units, fire and security systems, elevator systems, thermostats, lighting, and serviceable equipment (e.g., vending machines).

In brief overview, the BMS device described herein includes one or more processors and memory, storing instructions, that when carried out by one or more processors cause the BMS device to deliver and apply update packages to a host machine. The BMS device includes a container image repository storing container images. The container images can utilize a compose function to initialize and execute a container containing an update package. The container is an isolated computing environment isolated from the host machine. The container can copy the update package from the isolated computing environment into a mount point accessible by both the container and the host machine. The update package includes a software update, an arbitrary command, a script file, and/or any other system management tool configured to update an operating system, an arbitrary file, a system service, and/or any other system component on the host machine.

The container can send a message via a host abstraction layer to an application programming interface endpoint on the host machine. The message can cause the host machine to extract the update package from the mount point and apply the update package to the host machine to update one or more components of the host machine. In some embodiments, the BMS device can verify whether the one or more components updated successfully on the host machine and in response to the verification, the BMS device can remove the container. In embodiments where the BMS device fails to update one or more components of the host machine successfully, the BMS device can repeat initializing and executing the container to update one or more components of the host machine.

### Building and Building Management System

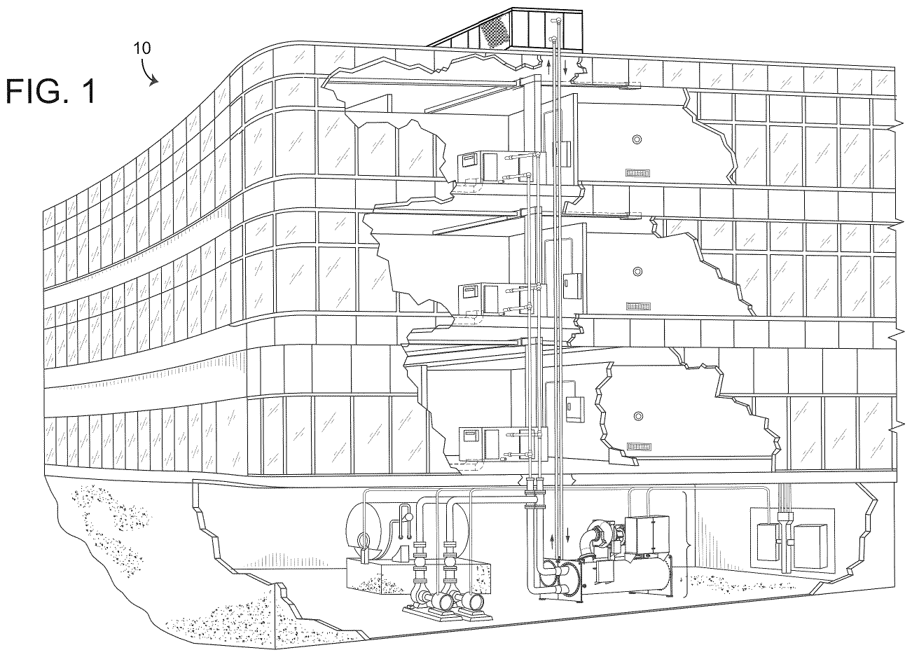

Referring now to FIG. 1, a perspective view of a building 10 is shown, according to an exemplary embodiment. A BMS serves building 10. The BMS for building 10 may include any number or type of devices that serve building 10. For example, each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, BMS devices may be connected to different communications networks or field controllers even if the devices serve the same area (e.g., floor, conference room, building zone, tenant area, etc.) or purpose (e.g., security, ventilation, cooling, heating, etc.).

BMS devices may collectively or individually be referred to as building equipment. Building equipment may include any number or type of BMS devices within or around building 10. For example, building equipment may include controllers, chillers, rooftop units, fire and security systems, elevator systems, thermostats, lighting, serviceable equipment (e.g., vending machines), and/or any other type of equipment that can be used to control, automate, or otherwise contribute to an environment, state, or condition of building 10. The terms “BMS devices,” “BMS device” and “building equipment” are used interchangeably throughout this disclosure.

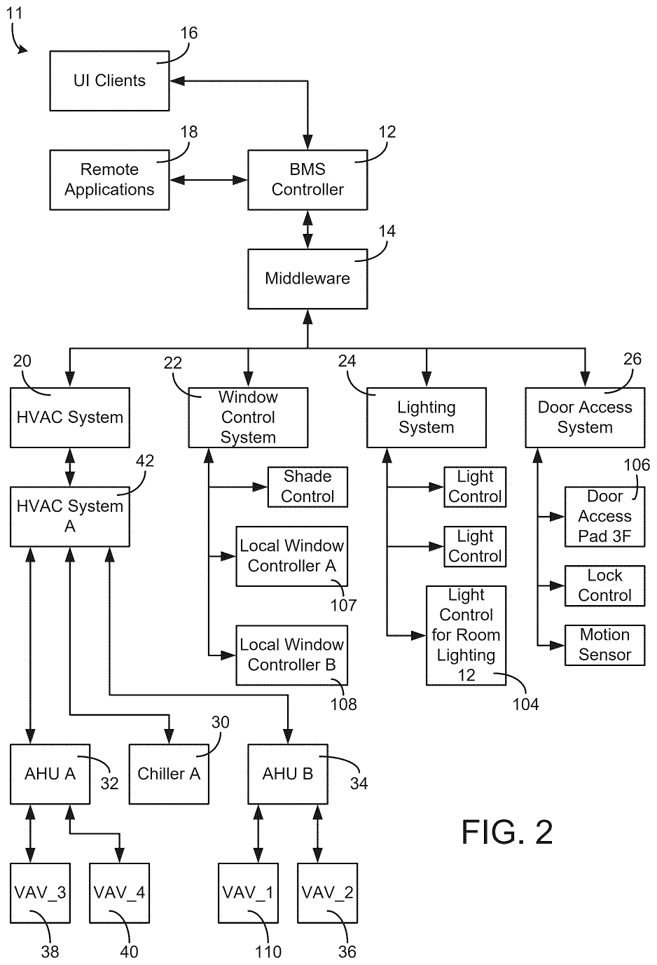

Referring now to FIG. 2, a block diagram of a BMS 11 for building 10 is shown, according to an exemplary embodiment. BMS 11 is shown to include a plurality of BMS subsystems 20-26. Each BMS subsystem 20-26 is connected to a plurality of BMS devices and makes data points for varying connected devices available to upstream BMS controller 12. Additionally, BMS subsystems 20-26 may encompass other lower-level subsystems. For example, an HVAC system may be broken down further as “HVAC system A,” “HVAC system B,” etc. In some buildings, multiple HVAC systems or subsystems may exist in parallel and may not be a part of the same HVAC system 20.

As shown in FIG. 2, BMS 11 may include a HVAC system 20. HVAC system 20 may control HVAC operations building 10. HVAC system 20 is shown to include a lower-level HVAC system 42 (named “HVAC system A”). HVAC system 42 may control HVAC operations for a specific floor or zone of building 10. HVAC system 42 may be connected to air handling units (AHUs) 32, 34 (named “AHU A” and “AHU B,” respectively, in BMS 11). AHU 32 may serve variable air volume (VAV) boxes 38, 40 (named “VAV_3” and “VAV_4” in BMS 11). Likewise, AHU 34 may serve VAV boxes 36 and 110 (named “VAV_2” and “VAV_1”). HVAC system 42 may also include chiller 30 (named “Chiller A” in BMS 11). Chiller 30 may provide chilled fluid to AHU 32 and/or to AHU 34. HVAC system 42 may receive data (i.e., BMS inputs such as temperature sensor readings, damper positions, temperature setpoints, etc.) from AHUs 32, 34. HVAC system 42 may provide such BMS inputs to HVAC system 20 and on to middleware 14 and BMS controller 12. Similarly, other BMS subsystems may receive inputs from other building devices or objects and provide the received inputs to BMS controller 12 (e.g., via middleware 14).

Middleware 14 may include services that allow interoperable communication to, from, or between disparate BMS subsystems 20-26 of BMS 11 (e.g., HVAC systems from different manufacturers, HVAC systems that communicate according to different protocols, security/fire systems, IT resources, door access systems, etc.). Middleware 14 may be, for example, an EnNet server sold by Johnson Controls, Inc. While middleware 14 is shown as separate from BMS controller 12, middleware 14 and BMS controller 12 may integrated in some embodiments. For example, middleware 14 may be a part of BMS controller 12.

Still referring to FIG. 2, window control system 22 may receive shade control information from one or more shade controls, ambient light level information from one or more light sensors, and/or other BMS inputs (e.g., sensor information, setpoint information, current state information, etc.) from downstream devices. Window control system 22 may include window controllers 107, 108 (e.g., named “local window controller A” and “local window controller B,” respectively, in BMS 11). Window controllers 107, 108 control the operation of subsets of window control system 22. For example, window controller 108 may control window blind or shade operations for a given room, floor, or building in the BMS.

Lighting system 24 may receive lighting related information from a plurality of downstream light controls (e.g., from room lighting 104). Door access system 26 may receive lock control, motion, state, or other door related information from a plurality of downstream door controls. Door access system 26 is shown to include door access pad 106 (named “Door Access Pad 3F”), which may grant or deny access to a building space (e.g., a floor, a conference room, an office, etc.) based on whether valid user credentials are scanned or entered (e.g., via a keypad, via a badge-scanning pad, etc.).

BMS subsystems 20-26 may be connected to BMS controller 12 via middleware 14 and may be configured to provide BMS controller 12 with BMS inputs from various BMS subsystems 20-26 and their varying downstream devices. BMS controller 12 may be configured to make differences in building subsystems transparent at the human-machine interface or client interface level (e.g., for connected or hosted user interface (UI) clients 16, remote applications 18, etc.). BMS controller 12 may be configured to describe or model different building devices and building subsystems using common or unified objects (e.g., software objects stored in memory) to help provide the transparency. Software equipment objects may allow developers to write applications capable of monitoring and/or controlling various types of building equipment regardless of equipment-specific variations (e.g., equipment model, equipment manufacturer, equipment version, etc.). Software building objects may allow developers to write applications capable of monitoring and/or controlling building zones on a zone-by-zone level regardless of the building subsystem makeup.

### Building Management System With Cloud-Based Monitoring and Control

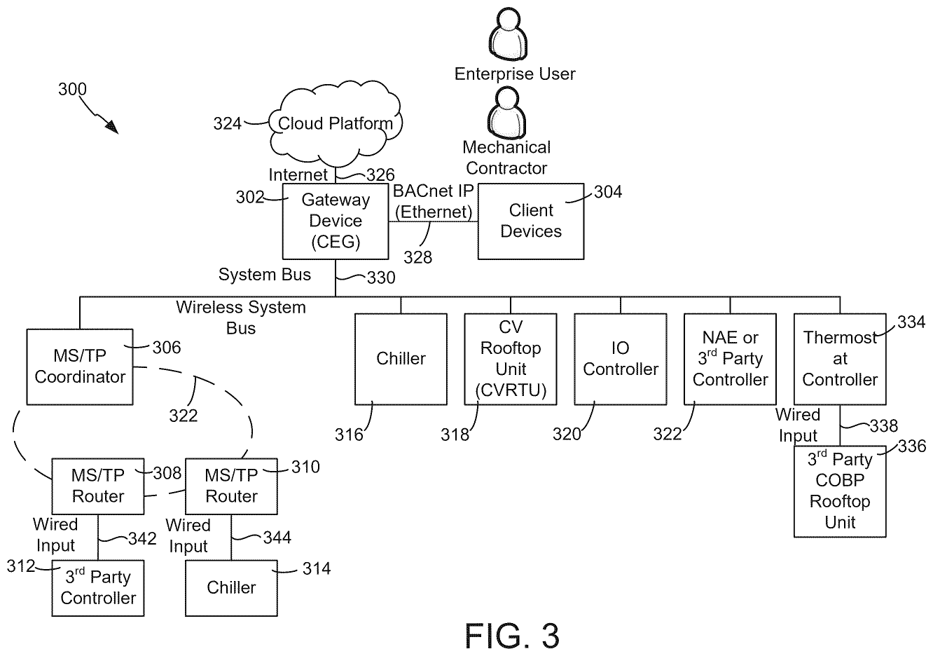

Referring now to FIG. 3, a block diagram of a building management system (BMS) 300 is shown, according to an exemplary embodiment. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. BMS 300 can be used to monitor and control the devices of HVAC system 20 and/or window control system 22, and/or lighting system 24, and/or door access system 26, as well as other types of BMS devices (e.g., BACnet MS/TP devices, security equipment, etc.).

In brief overview, BMS 300 provides a system architecture that facilitates central control of smart and non-smart building equipment of BMS 300 from a networked location. In some embodiments, BMS 300 can provide automatic equipment discovery and equipment model distribution. Equipment discovery can occur across multiple different communications networks (e.g., system bus, wireless system bus, etc.) and across multiple different communications protocols (e.g., LONworks, MODbus, BACnet, etc.). For the purposes of simplicity, this disclosure will describe a building management system with reference to the BACnet protocol, but it should be understood by one of ordinary skill in the art that other building management protocols may be used. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 300 can begin interacting with the new device (e.g., sending control signals, using data from the device) without user interaction.

Some devices in BMS 300 present themselves to the network using equipment models. An equipment model defines equipment object attributes, view definitions, schedules, trends, and the associated BACnet value objects (e.g., analog value, binary value, multistate value, etc.) that are used for integration with other systems. An equipment model for a device can include a collection of points objects that provide information about the device (e.g., device name, network address, model number, device type, etc.) and store present values of variables or parameters used by the device. For example, the equipment model can include point objects (e.g., standard BACnet point objects) that store the values of input variables accepted by the device (e.g., setpoint, control parameters, etc.), output variables provided by the device (e.g., temperature measurement, feedback signal, etc.), configuration parameters used by the device (e.g., operating mode, actuator stroke length, damper position, tuning parameters, etc.). The point objects in the equipment model can be mapped to variables or parameters stored within the device to expose those variables or parameters to external systems or devices. The equipment models and associated BACnet value objects and point objects can make up the building data that can be collected by BMS 300. For example, gateway device 302 can collect building data (e.g., output variables provided by the device) and communicate that building data to cloud platform 324 for processing and control of BMS 300.

In some embodiments, gateway device 302 automatically creates the equipment model for chiller 314 or other devices connected to it. Other gateway devices can also create equipment models for devices connected to them. The equipment model for a device can be created automatically based on the types of data points exposed by the device on the communications bus, device type, and/or other device attributes.

Still referring to FIG. 3, BMS 300 is shown to include a gateway device 302 (i.e., a connected equipment gateway). Gateway device 302 can communicate with client devices 304 (e.g., user devices, desktop computers, laptop computers, mobile devices, etc.) via a data communication link 328 (e.g., BACnet IP, Ethernet, wired or wireless communication, etc.). Gateway device 302 can provide a user interface to client devices 304 via data communications link 328. The user interface may allow users to monitor and/or control BMS 300 via client devices 304.

In some embodiments, gateway device 302 is connected to building equipment via a system bus 330. Building equipment can be devices of HVAC system 20 as well as other types of BMS devices (e.g., lighting equipment, security equipment, etc.) and/or any BACnet MS/TP master device. In some embodiments, building equipment are smart communicating equipment controllers, SC-EQ, manufactured by Johnson Controls, Inc.

System bus 330 can include any of a variety of communications hardware (e.g., wire, optical fiber, terminals, etc.) configured to facilitate communications between gateway device 302 and other devices connected to system bus 330. In some embodiments, system bus 330 can additionally include and/or alternatively be replaced by a wireless system bus, shown as a wireless system bus 332.

Wireless system bus 332 can include a plurality of wireless bridge devices forming a multi-point to multi-point network. The wireless bridge devices of wireless system bus 332 are shown as MS/TP coordinator 306 and MS/TP routers 308 and 310. In some embodiments, MS/TP coordinator 306 is a component of gateway device 302. Still in others, MS/TP coordinator 306 is a separate device and may be connected to gateway device 302 using a RJ12 or MS/TP COM port. MS/TP routers 308 and 310 interface between building equipment (e.g., MS/TP devices) such as controller 312 and chiller 314 to allow them to be discovered by MS/TP coordinator 306 and posted on system bus 330 as if the devices were connected directly to system bus 330. The multi-point to multi-point network can be a mesh network created between a MS/TP coordinator 306 and MS/TP routers 308 and 310. For example, the mesh network may be an 802.15.4 based network such as ZIGBEE. Wireless system bus 332 may allow the gateway device 302 to communicate with devices connected to via the wireless system bus 332. Wireless system bus devices may include any BACnet MS/TP device and/or any device that can be connected to gateway device 302 over system bus 330. Referring still to FIG. 3, wireless system bus devices can include controller 312 and chiller 314. Wireless system bus 332 may be configured so that the wireless system bus devices act as if they were connected directly to system bus 330. In some embodiments, neither the wireless system bus devices nor gateway device 302 are aware of the intermediate network of MS/TP devices. In some embodiments, the gateway device 302 is connected to a mix of devices over both system bus 330 and wireless system bus 332. For example, system bus 330 and wireless system bus 332 can connect gateway device 302 with controller 312, chiller 314, chiller 316, a constant volume (CV) rooftop unit (RTU) 318, input/output (IO) controller 320, network automation engine (NAE) or third-party controller 322, and thermostat controller 334 connected over wired input 338 to third-party rooftop unit 336.

In some embodiments, gateway device 302 is connected to wireless system bus 332 via system bus 330. In other embodiments, gateway device 302 is connected directly to wireless system bus 332. In some embodiments, BMS 300 operates only using wireless system bus 332. In some embodiments, BMS 300 can include both a wired system bus 330 and a wireless system bus 332, as shown in FIG. 3. Throughout this disclosure, the devices and building equipment connected to system bus 330 and wireless system bus 332 may be referred to together as system bus devices.

Gateway device 302 can be configured to communicate using a MS/TP protocol or any other communications protocol. Gateway device 302 can collect building data (e.g., equipment models, value objects, point objects, and/or any other data made available by building equipment) and communicate that data to cloud platform 324. Cloud platform 324 can process the data and direct gateway device 302 to collect specific data (e.g., listed value objects, point objects, etc.) from specific building equipment. Gateway device 302 can subscribe to the indicated objects and communicate the data to cloud platform 324 periodically.

Still referring to FIG. 3, gateway device 302 can be configured to communicate with cloud platform 324 via an internet communications link 326 (e.g., Wi-Fi, Ethernet, cellular, etc.). In some embodiments, internet communications link 326 may be provided by external network adapters attached to gateway device 302, as explained in further detail below. Gateway device 302 may be configured to connect the building equipment (e.g., chillers, controllers, RTUs, and/or other MS/TP devices) on the trunk (e.g., system bus 330, wireless system bus 332, etc.) to cloud platform 324. Gateway device 302 can facilitate the communication of building data from building equipment to cloud platform 324. The user interface may allow users to view the building data and/or monitor and control this connection to manage BMS 300, including the data rate between gateway device 302, the building equipment, and cloud platform 324. Gateway device 302 can be configured to automatically discover equipment in BMS 300 and automatically generate or obtain equipment models for the discovered equipment. Gateway device 302 can also be configured to gather more data from the equipment (e.g., equipment model templates) and to use the equipment model templates to drive features of gateway device 302.

Cloud platform 324 can include a variety of cloud-based services and/or applications configured to store, process, analyze, or otherwise consume the data collected from gateway device 302. Cloud platform 324 may be accessed by various users (e.g., enterprise users, mechanical contractors, cloud application users, etc.) via control applications. Some users can access and interact with gateway device 302 directly via client devices 304 (e.g., via a UI provided locally by gateway device 302), whereas other users can interact with cloud platform 324 (e.g., via a UI provided by cloud platform 324). Users can interact with cloud platform 324 via control applications configured to display the building data and provide a user with control of the gateway device 302. The features of cloud platform 324 and gateway device 302 are described in greater detail below.

Gateway device 302 can provide a user interface for any device containing an equipment model. Building equipment such as thermostat controller 334 can provide their equipment models to gateway device 302 via system bus 330. In some embodiments, gateway device 302 automatically creates equipment models for connected devices that do not contain an equipment model (e.g., non-smart equipment, legacy equipment, third-party equipment, etc.). For example, gateway device 302 can create an equipment model for any device that responds to a device tree request. In some embodiments, gateway device 302 can create an equipment model for any device that responds to a read object list attributes request. The equipment models created by gateway device 302 can be stored within gateway device 302 and/or transferred to cloud platform 324. Gateway device 302 can then provide a user interface for devices that do not contain their own equipment models using the equipment models created by gateway device 302. In some embodiments, gateway device 302 stores a view definition for each type of equipment connected via system bus 330 and wireless system bus 332 and uses the stored view definition to generate a user interface for the equipment.

### Containerization of Update Packages on BMS Devices

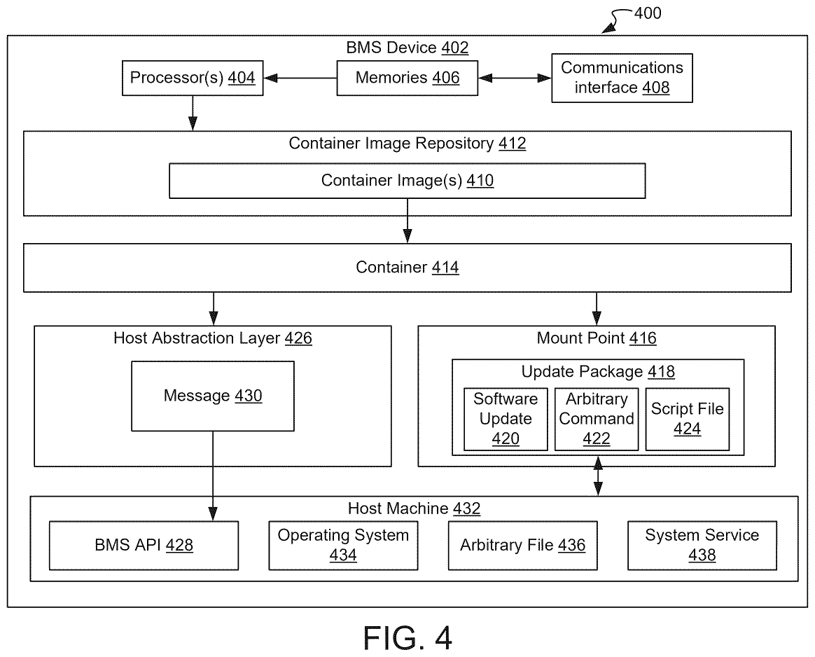

Referring now to FIG. 4, a block diagram of an example system 400 including an example BMS device 402 that implements containerized update packages 418 (e.g., software update 420, arbitrary command 422, script file 424, etc.) is shown, in accordance with one or more embodiments. The BMS device 402 is configured to monitor and control building functions (e.g., HVAC control, lighting control, energy management, etc.) and can be implemented on-premises (e.g., within the building) or off-premises (e.g., outside the building). The terms “BMS devices,” “BMS device,” “host machine,” and “building equipment” are used interchangeably throughout this disclosure.

The BMS device 402 can include one or more processors 404 and one or more memories 406. The processor(s) 404 can include a general purpose or specific purpose processors, an ASIC, a graphical processing unit (GPU) one or more field programmable gate arrays, a group of processing components, or other suitable processing components. The processor(s) 404 may be configured to execute computer code and/or instructions stored in the memories 406 or received from other computer readable media (e.g., CDROM, network storage, a remote server, etc.).

The memories 406 can include one or more devices (e.g., memory units, memory devices, storage devices, etc.) for storing data or computer code for completing or facilitating the various processes described in the present disclosure. The memories 406 can include RAM, ROM, hard drive storage, temporary storage, non-volatile memory, flash memory, optical memory, or any other suitable memory for storing software objects or computer instructions. The memories 406 can include database components, object code components, script components, or any other type of information structure for supporting the various activities and information structures described in the present disclosure. The memories 406 can be communicably connected to the processors 404 and can include computer code for executing (e.g., by the processors 404) one or more processes described herein. In some embodiments, the components of the BMS device 402 (e.g., container image 410, container image repository 412, container 414, mount point 416, update package 418, host abstraction layer 426, host machine 432, etc.), except the processor 404, are components of the memories 406.

The BMS device 402 can include one or more network interfaces, shown as communications interface 408. Communications interface 408 can facilitate communications between BMS device 402 and external systems, devices, or applications. For example, communications interface 408 can be used by BMS device 402 to communicate with client device 304 (e.g., a tablet, a laptop computer, a smartphone, a desktop computer, a computer workstation, etc.), monitoring and reporting applications, enterprise control applications, remote systems and applications, and/or other external systems or devices for allowing user control, monitoring, and adjustment to BMS 300 and/or BMS device 402.

Communications interface 408 can include wired or wireless communications interfaces (e.g., jacks, antennas, transmitters, receivers, transceivers, wire terminals, etc.) for conducting data communications with client device 304 or other external systems or devices. In various embodiments, communications conducted via interface 408 can be direct (e.g., local wired or wireless communications) or via a communications network (e.g., a WAN, the Internet). Communications interface 408 can conduct communication using a variety of network protocols (e.g., BACnet MS/TP, BACnet IP, MODbus, etc.). In various embodiments, communications can be conducted over various network types (e.g., a cellular network, Wi-Fi network, ZIGBEE network, etc.). For example, communications interface 408 can include an Ethernet card and port for sending and receiving data via an Ethernet-based communications link or network. In another example, communications interface 408 can include a Wi-Fi transceiver for communicating via a wireless communications network. In another example, communications interface 408 can include cellular or mobile phone communications transceivers. In one embodiment, communications interface 408 is a power line communications interface and/or an Ethernet interface. In some embodiments, client devices 304 can communicate directly to BMS device 402 via communications link 408 without going through cloud platform 324.

In some embodiments, the above network interfaces are components of communications interface 408. In some embodiments, the network interfaces require external network adapters to facilitate communicate over various networks. The external network adapters may be detachable network adapters. For example, the external network adapters may be USB “dongles” configured to provide network connectivity over USB to connected devices. BMS device 402 can be configured to automatically operate a network adapter that is attached. The detachable external network adapters can connect to BMS device 402 via communications interface 408.

As shown, the BMS device 402 can store one or more container images 410, which may include full system images that store software for the BMS device 402 in one or more container image repositories 412. The container images 410 can be requested by or communicated to the BMS device 402. The container images 410 stored by the BMS device 402 can be specific to (e.g., include software compiled or otherwise configured for) particular BMS devices (e.g., the BMS device 402, other BMS devices described herein, etc.).

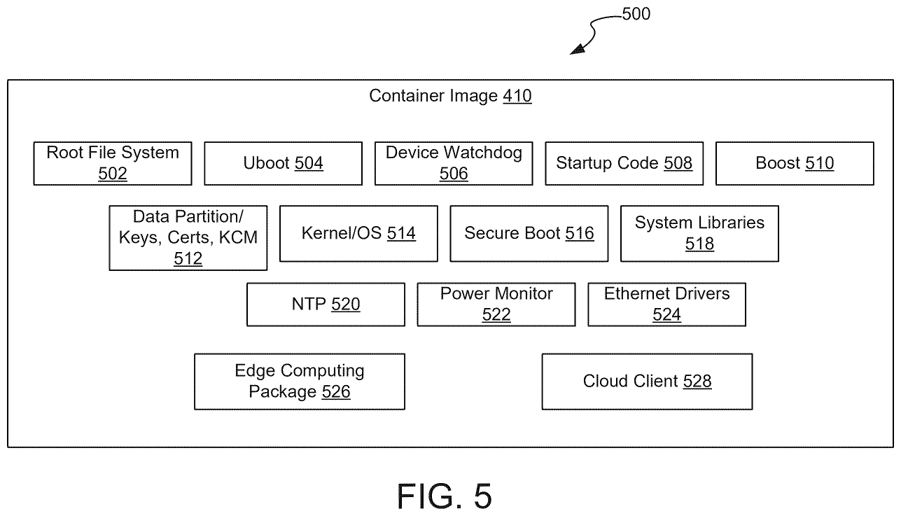

Prior to discussing the functionality of the BMS device 402, an example container image (e.g., one or more of the container images 410) will be described in connection with FIG. 5. Referring to FIG. 5 in the context of the components described in connection with FIG. 4, illustrated is a block diagram 500 of an example container image 410 that may be implemented by the BMS device 402 described in connection with FIG. 4, in accordance with one or more implementations. The container image 410 may be a serialized copy of the entire state of a computer system stored in a non-volatile format. For example, the container image 410 can include a root file system 502, which may include a file system and a directory structure for storing one or more of the files described herein.

The container image 410 can include a boot loader, shown here as UBoot 504. The UBoot 504 can include software written in machine code that loads the operating system 514 into RAM during the boot process, and initiates execution of the operating system 514. The container image 410 may specify that UBoot 504 be stored at a predetermined location in the memory of the BMS device 402 with which the container image 410 is configured.

The container image 410 may include a device watchdog 506. The device watchdog 506 can be utilized to automatically reset the BMS device 402 if certain conditions are not met. For example, the device watchdog 506 can be a script or other processor-executable software that monitors the configuration of one or more container 414 as the containers 414 are initialized by the operating system 514. The device watchdog 506 can determine that a particular container 414 has an error or has become unresponsive during initialization or execution. The device watchdog 506 can generate a record of the error or unresponsive container 414 and may automatically reset the BMS device 402. In some embodiments, the device watchdog 506 can request automatic reconfiguration (e.g., re-flashing the container image 410, upgrading one or more unresponsive containers, etc.) of the BMS device 402 in response to detecting one of the aforementioned conditions.

The container image 410 may include startup code 508, which may include scripts or other processor-executable instructions that initialize one or more containers 414 and other software implemented by the BMS device 402. When the operating system 514 of the BMS device 402 is initialized, the operating system 514 may execute one or more of the startup scripts 508 to initialize the container 414. For example, the BMS device 402 may execute the startup scripts 508 to initiate a Docker compose, which may use first instruction stored in the container image 410 to cause various containers (e.g., the container 414, etc.) to become initialized.

The container image 410 can include one or more libraries, such as the Boost libraries 510, which provide a suite of functions and computer-executable instructions that can be utilized to implement the various functionalities of the BMS device 402. The container image 410 can include the system libraries 518, which may include libraries that provide low-level access to system functionalities of the BMS device 402. The container image 410 can include one or more encrypted keys, certificates, or key continuity management (KCM) functionalities, which may be stored in a separate data partition 512.

The container image 410 can include the operating system 514, which may include a kernel, machine code, or other processor-executable instructions that enable management of the various processes that may execute on the BMS device 402. The operating system 514 can coordinate scheduling, initiating, and terminating different processes in both user space and kernel space. The operating system 514 can manage memory for the various components of the BMS device 402. The operating system 514 can perform system-level management of hardware devices, including loading, implementing, and executing device drivers for various hardware interfaces of the BMS device 402. Examples of such drivers include the Ethernet drivers 524, among others. The operating system 514 may also execute or coordinate various protocols, including the Network Time Protocol (NTP) 520. The NTP 520 can be utilized to synchronize time over a network (e.g., by transmitting a request for the current time to a server and setting a system time to the value retrieved from the server). The operating system 514 can implement one or more power monitors 522, which may monitor the voltage or usage of power from one or more batteries or other external power sources.

The container image 410 can include the edge computing package 526. The edge computing package 526 can include any of the containers 414 or other software implemented by the BMS device 402 as described herein. The edge computing package 526 can include, for example, software that implements the host abstraction layer 426, software that implements the BMS application programming interface (BMS API) 428, software that implements an analytical engine, a logger, a log rotator (e.g., implementing a log rotation policy), and software that initializes the containerized components described herein (e.g., the container 414). For example, the edge computing package 526 may include a container initialization script (or other processor-executable instructions), configuration data for the containers, among other data related to the containers as described herein.

Referring back to FIG. 4, the BMS device 402 can include one or more containers 414. Each of the containers 414, as described herein, is a software package for one or more applications that includes code, and all its dependencies, so the one or more applications can execute quickly and reliably from one computing environment to another. Containers 414 can be isolated computing environments that include executable packages of software that includes code, runtime, system tools, system libraries and configuration settings. Containers 414 can be distributed as “container images,” (i.e., container image 410, Docker container images, etc.) which can be loaded and executed by a container manager of the BMS device 402. Each container 414 may maintain its own storage. In some embodiments, a container 414 can generate a mount point 416. The mount point 416 is a shared region of memory that can be accessed by one or more containers 414 and one or more BMS devices 402 with read access, write access, or read and write access. Read and write permissions for one or more mount points 416 can be specified in the configuration of the respective container 414, from other configuration settings. The containers 414 can copy one or more update packages 418 (e.g., software update 420, arbitrary command 422, script file 424, etc.) from the isolated computing environment to the mount point 416. The one or more update packages 418 are configured to update one or more components of the host machine 432 according to the update package 418.

To communicate with other containers, software, or hardware, each container 414 described herein may generate a message 430 (e.g., interprocess communication message, etc.) that allows for communication, via the host abstraction layer 426, with an application programming interface endpoint 428 on the host machine 432. The host abstraction layer 426 is a single software component on the BMS device 402 that may facilitate communication between the container 414 and the host machine 432. The message 430 may cause the BMS device 402 to access the mount point 416 and extract one or more update packages 418 from the mount point 416 and apply the update package 418 to the host machine 432. The one or more update packages 418 is configured to update one or more components of the BMS device 402 (e.g., operating system 434, arbitrary files 436, system services 438, etc.).

### Delivering and Applying Containerized Update Packages

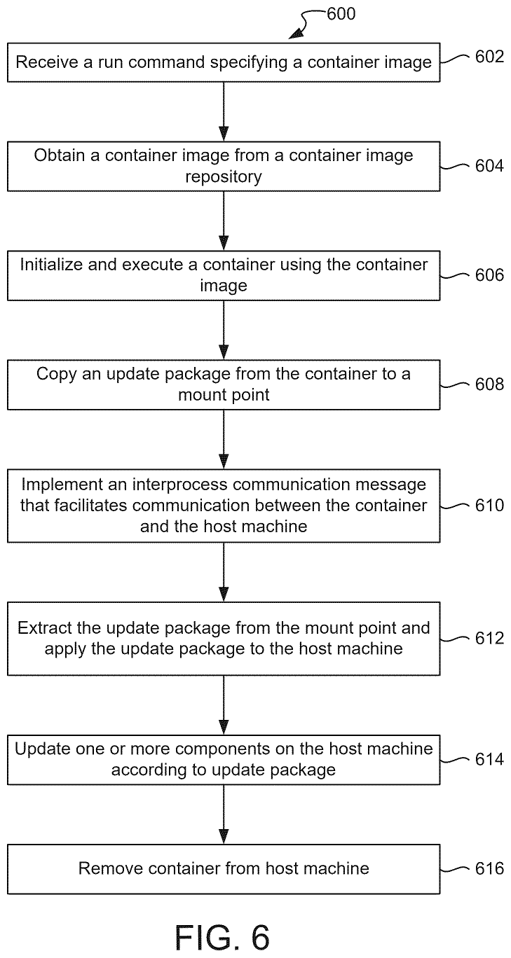

Referring now to FIG. 6, a flow diagram of an example method 600 for the delivering and applying updates to BMS devices 402, in accordance with one or more implementations. In various embodiments the BMS device 402 preforms the method 600. However, it should be understood that any computing system described herein may perform any or all of the operations described in connection with the method 600. The computing system performing the operations of the method 600 is referred to in the following description as the “BMS device” or “host machine.” The method includes steps 602-616, however it should be understood that steps may be removed, performed in an alternate order, or additional steps may be performed, which still achieve useful results.

At step 602, the BMS device 402 receives a run command (e.g., Docker run command, FogHorn Manager sold by Johnson Controls, etc.). The run command includes the base command (e.g., docker run), the container image 410 name, other commands (e.g., commands to run inside the container 414, etc.), and container options. The run command can invoke a virtualized environment manager (e.g., Docker daemon, etc.) to obtain the container image 410 (e.g., specify name of container image 410 to retrieve container, etc.) and initialize and execute the container 414. In some embodiments, the run command is received internally from the BMS device 402 (e.g., cloud platform on the BMS device, etc.) or externally (e.g., other BMS devices, user interacting with the BMS device 402, etc.).

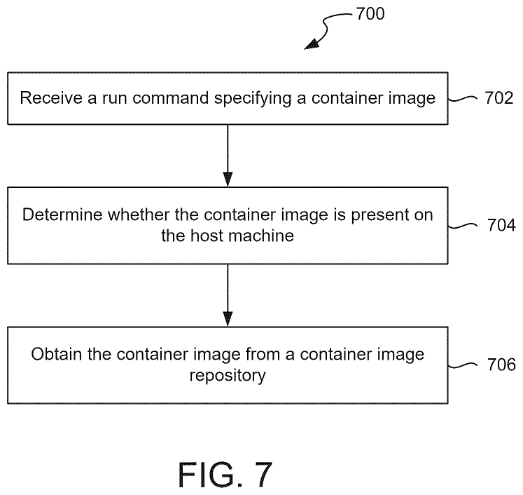

At step 604, the BMS device 402 obtains the container image 410 stored on the BMS device 402. The container images 410 may be present on the BMS device 402. In embodiments where the container image 410 is absent from the BMS device 402, the BMS device 402 can obtain the container image 410 from a container image repository 412 (Docker registry, private registry, etc.). An example method for verifying and retrieving a container image 410 from a container image repository 412 will be described in connection with method 700 of FIG. 7. Referring to method 700, as shown in FIG. 7 in the context of the steps comprised in method 600 as shown in FIG. 6 illustrated is an example method 700 for retrieving a container image 410 from a container image repository 412 in response to the container image 410 being absent from the BMS device 402, in accordance with one or more implementations.

Referring to FIG. 7, an example flow diagram of the method 700 for verifying and retrieving a container image 410 from a container image repository 412 is shown in accordance with one or more implementations. At step 702 the BMS device 402 receives a run command specifying a desired container image 410. The run command includes the base command (e.g., docker run), the container image 410 name, other commands (e.g., commands to run inside the container 414, etc.), and container options. The run command can invoke a virtualized environment manager (e.g., Docker daemon, etc.) to obtain a container image 410 (e.g., specify name of container image 410 to retrieve container 414, etc.) and initialize and execute a container 414. In some embodiments, the run command is received internally from the BMS device 402 (e.g., cloud platform on the BMS device 402, etc.) or externally (e.g., other BMS devices, user interacting with the BMS device 402, etc.). Step 702 in method 700 can be step 602 in method 600, for example.

At step 704, the BMS device 402 determines whether the container image 410 is present on the BMS device 402 (e.g., local repository, etc.). The BMS device 402 can confirm the container image 410 is present when a container image 410 on the BMS device 402 is the same as the container image 410 specified in the run command (e.g., container image 410 name on the BMS device 402 is the same as container image 410 name specified in run command). The BMS device 402 can confirm the container image 410 is absent from the BMS device 402 when a container image 410 on the BMS device 402 is different from the container image 410 specified in the run command (e.g., container image 410 name on the BMS device 402 is different from the container image 410 name in run command).

At step 706, in embodiments where the container image 410 is found to be absent from the BMS device 402 the BMS device 402 may obtain the container image 410 from a container image repository 412 (Docker registry, private registry, etc.). The BMS device 402 can use a command (e.g., docker pull command, etc.) to pull the container image 410 from the container image repository 412 to the BMS device 402. In some embodiments, wherein the container image repository 412 is a private container image repository (e.g., private registry, etc.) the container image 410 may be verified by an inbuilt content trust system (e.g., Docker inbuilt content trust system, etc.) prior to obtaining the container image 410.

Referring now to FIG. 6 at step 606, the BMS device 402 initializes and executes the container 414 using the container image 410. When the operating system 514 of the container image 410 is initialized, the operating system 514 may execute one or more of the startup scripts 508 to initialize the container 414. For example, the BMS device 402 may execute the startup scripts 508 to initiate a Docker compose, which may use first instructions stored in the container image 410 to cause a container 414 to become initialized.

At step 608, the container 414 can copy (e.g., direct copy, copy using container commands, etc.) the update package 418 (e.g., software update 420, arbitrary command 422, script file 424, etc.) from the isolated computing environment to the mount point 416. The mount point 416 is a shared region of memory which may be accessed by the container 414 and the BMS device 402. The mount point 416 may be on the on the BMS device 402 (e.g., local file system mounts, bind mounts, Docker volumes, etc.) or on a network (e.g., cloud storage mounts, ISO image mounts, network file system, etc.). In some embodiments, the container 414 may not copy the update package 418 directly from the isolated computing environment to the mount point 416.

At step 610, the container 414 may generate a message 430 (e.g., interprocess communication message, D-Bus command, virtual bus command, etc.) that allows for communication, via the host abstraction layer 426 (e.g., containerization layer), with an application programming interface endpoint 428 on the host machine 432. In some embodiments, the communication between the container 414 and the host machine 432 can trigger actions (e.g., extract the update package from the mount point 416, etc.) that may update one or more components of the BMS device 402.

At step 612, the BMS device 402 can extract the update package 418 from the mount point 416 and apply the update package 418 to the host machine 432. In response to receiving the message 430 from the container 414, the host machine 432 may access the mount point 416 and extract the update package 418. For example, to extract an update package 418 from a docker mount point the BMS device 402 can navigate to the mount point 416 and copy the update package 418 from the mount point 416 to the host machine 432.

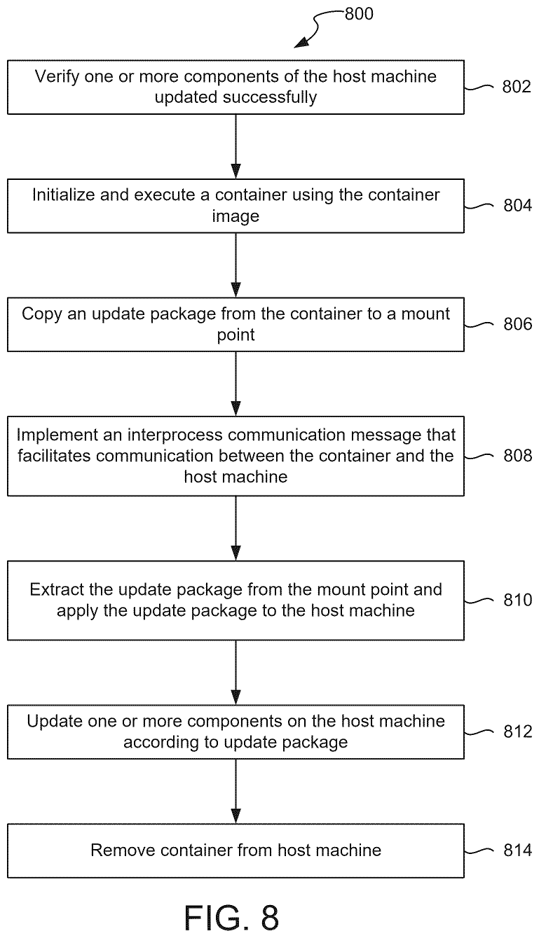

At step 614, the BMS device 402 can update one or more components on the host machine 432 according to contents of the update package 418. In some embodiments, the update package 418 can contain a software update 420, which is configured to update the operating system 434 (e.g., fix bugs, enhance performance, improve security, introduce new features, etc.), the arbitrary file 436 (e.g., replacing, modifying, adding content to the file, etc.), the system services 438 (e.g., replacing, modifying, adding files, configuration settings or binaries, etc.), and/or any other system management tool configured to update the host machine 432. In some embodiments, the update package 418 can contain an arbitrary command 422, which is configured to update the operating system 434 (e.g., applying security patches, configuring system settings, installing new software, etc.), the arbitrary file 436 (e.g., changing file content, permissions, metadata, etc.), the system service 438 (e.g., starting, stopping, restarting, reconfiguring a system service) and/or any other system management tool configured to update the host machine 432. In some embodiments, the update package 418 can contain the script file 424, which is configured to update the operating system 434 (e.g., applying security patches, configuring system settings, installing new software, etc.), the arbitrary file 436 (e.g., edit text files, replace text file content, append data, modify permissions, etc.), the system service 438 (e.g., automate changes to service operations, configure system services, apply updates to the system service, etc.) and/or any other system management tool configured to update the host machine 432. In some embodiments, the update package 418 can update the container 414 and/or the container image 410 on the BMS device 402. In some embodiments, the update package 418 fails to update the host machine 432 and may execute the method 800 as shown in FIG. 8.

Referring to FIG. 8, an example flow diagram of a method 800 for delivering and applying update packages 418 to the BMS device 402 in response to a failure to update the host machine 432 is shown, in accordance with one of more embodiment. At step 802, the BMS device 402 verifies the one or more components of the host machine 432 updated successfully. For example, the BMS device 402 may send a message to a client device 304 (e.g., confirmation message, etc.) and/or the user may manually verify the completion of the update (e.g., check version, etc.) of one or more components of the host machine 432.

At step 804, the BMS device 402 repeats initializing and executing the container 414 using the container image 410 in response to the failure to update the host machine 432 as shown in step 802. When the operating system 514 of the container image 410 is initialized, the operating system 514 may execute one or more of the startup scripts 508 to initialize the container 414. For example, the BMS device 402 may repeat execution of the startup scripts 508 to initiate a Docker compose, which may use first instructions stored in the container image 410 to cause a container 414 to become initialized.

At step 806, the container 414 can copy (e.g., direct copy, copy using container commands, etc.) the update package 418 (e.g., software update 420, arbitrary command 422, script file 424, etc.) from the isolated computing environment to the mount point 416. The mount point 416 is a shared region of memory which may be accessed by the container 414 and the BMS device 402. The mount point 416 may be on the BMS device 402 (e.g., local file system mounts, bind mounts, Docker volumes, etc.) or on a network (e.g., cloud storage mounts, ISO image mounts, Network file system, etc.). In some embodiments, the container 414 may not copy the update package 418 directly from the isolated computing environment to the mount point 416.

At step 808, the container 414 may generate a message 430 (e.g., interprocess communication message, D-Bus command, virtual bus command, etc.) that allows for communication, via the host abstraction layer 426 (e.g., containerization layer), with an application programming interface endpoint 428 on the host machine 432. In some embodiments, the communication between the container 414 and the host machine 432 can trigger actions (e.g., extract the update package from the mount point 416, etc.) that may affect one or more components of the BMS device 402.

At step 810, the BMS device 402 can repeat extracting the update package 418 from the mount point 416 and applying the update package 418 to the host machine 432. In response to receiving the message 430 from the container 414, the host machine 432 may access the mount point 416 and extract the update package 418. For example, to extract an update package 418 from a docker mount point, the BMS device 402 can navigate to the mount point 416 and copy the update package 418 from the mount point 416 to the host machine 432.

At step 812, the BMS device 402 can repeat updating one or more components on the host machine 432 according to contents of the update package 418. In some embodiments, the update package 418 can contain a software update 420, which is configured to update the operating system 434 (e.g., fix bugs, enhance performance, improve security, introduce new features, etc.), the arbitrary file 436 (e.g., replacing, modifying, adding content to the file, etc.), the system services 438 (e.g., replacing, modifying, adding files, configuration settings or binaries, etc.), and/or any other system management tool configured to update the host machine 432. In some embodiments, the update package 418 can contain an arbitrary command 422, which is configured to update the operating system 434 (e.g., applying security patches, configuring system settings, installing new software, etc.), the arbitrary file 436 (e.g., changing file content, permissions, metadata, etc.), the system service 438 (e.g., starting, stopping, restarting, reconfiguring a system service), and/or any other system management tool configured to update the host machine 432. In some embodiments, the update package 418 can contain the script file 424, which is configured to update the operating system 434 (e.g., applying security patches, configuring system settings, installing new software, etc.), the arbitrary file 436 (e.g., edit text files, replace text file content, append data, modify permissions, etc.), the system service 438 (e.g., automate changes to service operations, configure system services, apply updates to the system service, etc.), and/or any other system management tool configured to update the host machine 432. In some embodiments, the update package 418 can update the container 414 and/or the container image 410 on the BMS device 402.

Referring now to FIGS. 6 and 8, at step 616 and 814 in response to a verification of a successful update of the host machine 432 the BMS device 402 can remove the container 414 from the BMS device 402 to improve functionality of the BMS device 402 (e.g., storage management, security, resource management, etc.). For example, the BMS device 402 may identify the container 414 for removal (e.g., by viewing active and inactive containers, receiving a command specifying container name, etc.) and send a removal command specifying the container 414 that is to be removed from the BMS device 402. In some embodiments, the container 414 is removed automatically after the completion of an update of one or more components on the host machine 432. In some embodiments, the container 414 is removed by a user sending a command from a client device 304 to the BMS device 402.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system for delivering and applying updates to building management system (BMS) devices, the system comprising:
a container image repository storing a plurality of container images; and
a BMS device comprising one or more processors and memory storing instructions that, when executed by the one or more processors, cause the one or more processors to perform operations comprising:
obtaining a container image from the container image repository;
initializing and executing a container on the BMS device using the container image, wherein the container comprises an isolated computing environment isolated from a host machine of the BMS device and executing the container comprises copying an update package from the isolated computing environment within the container to a mount point accessible by both the container and the host machine; and
sending a message from the container to the host machine, wherein the message causes the host machine to access the update package in the mount point and update one or more components of the host machine using the update package.

2. The system of claim 1, wherein the BMS device is configured to:
receive a run command specifying a container image;
determine whether the container image is present on the host machine; and
in response to the container image being absent from the host machine, obtain the container image from the container image repository.

3. The system of claim 1, wherein the BMS device is configured to:
utilize the compose function, wherein the compose function initializes the container utilizing first instructions in the container image.

4. The system of claim 1, wherein the BMS device is configured to verify the container image using an inbuilt content trust system installed on the host machine.

5. The system of claim 1, wherein the update package comprises at least one of a software update, an arbitrary command, or script file configured to update the host machine.

6. The system of claim 1, wherein the message is an interprocess communication message comprising a D-Bus command wherein the message is sent via a host abstraction layer to an application programming interface endpoint on the host machine.

7. The system of claim 1, wherein the BMS device is configured to:
verify whether the one or more components of the host machine updated successfully; and
in response to determining that the one or more components of the host machine failed to update successfully, repeat initializing and executing the container using the container image, sending the message from the container to the host machine, accessing the update package in the mount point, and updating the one or more components of the host machine using the update package.

8. The system of claim 1, wherein the BMS device is configured to:
verify whether one or more components of the host machine updated successfully; and
in response to determining that the one or more components of the host machine update successfully, remove the container from the BMS device.

9. The system of claim 1, wherein the BMS device is configured to:
update at least one of an operating system, a system service, an arbitrary file, the container image, or the container according to the update package.

10. A method for delivering and applying updates to building management system (BMS) devices, the method comprising:
obtaining, by a BMS device, a container image from a container image repository;
initializing and executing a container on the BMS device using the container image, wherein the container comprises an isolated computing environment isolated from a host machine of the BMS device and executing the container comprises copying an update package from the isolated computing environment within the container to a mount point accessible by both the container and the host machine; and
sending a message from the container to the host machine, wherein the message causes the host machine to access the update package in the mount point and update one or more components of the host machine using the update package.

11. The method of claim 10, wherein obtaining the container image comprises:
receiving a run command that specifies the container image;
determining whether the container image is present on the host machine; and
in response to the container image being absent from the host machine, obtaining the container image from the container image repository.

12. The method of claim 10, wherein initializing and executing a container comprises:
utilizing a compose function, wherein the compose function initializes the container utilizing first instructions in the container image.

13. The method of claim 10, wherein obtaining the container image comprises:
verifying the container image using an inbuilt content trust system installed on the host machine.

14. The method of claim 10, wherein the update package comprises at least one of a software update, an arbitrary command, or script file configured to update the host machine.

15. The method of claim 10, wherein the message is an interprocess communication message comprising a D-Bus command wherein the message is sent via a host abstraction layer to an application programming interface endpoint on the host machine.

16. The method of claim 10, comprising:
verifying whether the one or more components of the host machine updated successfully; and
in response to determining that the one or more components of the host machine failed to update successfully, repeat initializing and executing the container using the container image, sending the message from the container to the host machine, accessing the update package in the mount point, and updating the one or more components of the host machine using the update package.

17. The method of claim 10, comprising:
verifying whether the one or more components of the host machine updated successfully; and
in response to determining that the one or more components of the host machine updated successfully, removing the container from the host machine.

18. The method of claim 10, comprising:
updating at least one of an operating system, a system service, an arbitrary file, the container image, or the container according to the update package.

19. A system for delivering and applying updates to building management system (BMS) devices, the system comprising:
a container image repository storing a plurality of container images; and
one or more non-transitory computer-readable media storing instructions that, when executed by one or more processors, cause the one or more processors to perform operations comprising:
obtaining, by a BMS device, a container image from a container image repository;
initializing and executing a container on the BMS device using the container image, wherein the container comprises an isolated computing environment isolated from a host machine of the BMS device and executing the container comprises copying an update package from the isolated computing environment within the container to a mount point accessible by both the container and the host machine; and
sending a message from the container to the host machine, wherein the message causes the host machine to access the update package in the mount point and update one or more components of the host machine using the update package.

20. The method of claim 19, comprising:
verifying whether the one or more components of the host machine updated successfully; and
in response to determining that the one or more components of the host machine updated successfully, removing the container from the host machine.
